(19) United States
(12) Patent Application Publication
(10) Pub. No.: US 2009/0295700 A1
(43) Pub. Date: Dec. 3, 2009

(54) Display Device

(75) Inventors: Osamu Nagashima, Mobara (JP); Nobuyuki Ishige, Shirako (JP); Koichi Igeta, Chiba (JP); Yuji Maede, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/473,297

(22) Filed: May 28, 2009

(30) Foreign Application Priority Data
May 30, 2008 (JP) 2008-143757

(51) Int. Cl. G09G 3/36

(52) U.S. Cl. 345/92

(57) ABSTRACT

A display device includes a display region which is constituted of a plurality of partial regions, and drive circuits which are connected to a plurality of video signal lines for respective partial regions. The video signal lines and the drive circuits are connected with each other via relay lines. A center line of the drive circuit and a center line of the partial region are arranged at positions displaced from each other, and the relay lines have a bent portion between the drive circuit and the video signal lines. By forming the bent portion on the relay line, the line resistances of the relay lines can be adjusted thus decreasing display irregularities generated by the positional displacement of the drive circuit.

### CROSS-REFERENCE TO RELATED APPLICATION

The present application claims priority from Japanese application JP2008-143757 filed on May 30, 2008, the content of which is hereby incorporated by reference into this application.

### BACKGROUND OF THE INVENTION

1. Field of the Invention

The present invention relates to a display device in which video signals are supplied to a plurality of video signal lines arranged parallel to each other within a display region from a plurality of drive circuits, and a control circuit which controls an operation of the plurality of these drive circuits is arranged on a substrate which includes the display region.

2. Description of the Related Art

In a display device such as a liquid crystal display device, a plurality of pixels is arranged in a matrix array within a display region on an array substrate, and an image is displayed by controlling a display of each pixel. To be more specific, a plurality of video signal lines is arranged parallel to each other within the display region, and electric signals (video signals) are supplied to the respective pixels via the video signal lines so that the display of each pixel is controlled. For example, in case of a TFT-type liquid crystal display device, within a display region, a plurality of scanning signal lines which extends in the lateral direction of the display region and is arranged parallel to each other in the longitudinal direction of the display region is arranged, and a plurality of video signal lines which extends in the direction which intersects the scanning signal lines (the longitudinal direction of the display region) and is arranged parallel to each other in the lateral direction is arranged. Respective regions defined by these scanning signal lines and video signal lines correspond to pixels of the display device, and a thin film transistor (TFT) which functions as a switch element for driving each pixel is connected to the scanning signal line and the video signal line respectively. Due to the combination of a scanning signal supplied via the scanning signal line and a video signal supplied via the video signal line, the pixel which is subject to a display control is selected. By applying a voltage to a pixel electrode of the selected pixel via the thin film transistor, the direction of liquid crystal molecules and the like are controlled so that a display of the pixels is controlled.

Such a display device includes a drive circuit which supplies electric signals to respective signal lines. A plurality of drive circuits is provided for the video signal lines, or a plurality of drive circuits is provided for the scanning signal lines. There may be a case that each one of the plurality of drive circuits is allocated to the supply of electric signals to a plurality of signal lines. To be more specific, in a case where the video signals are supplied to M pieces of video signal lines in total from N pieces of video signal line drive circuits (drain drivers), each one of N pieces of drain drivers corresponds to any one of partial regions which are formed by dividing the display region in N in the lateral direction, and each drain driver supplies signals to M/N pieces of video signal lines arranged parallel to each other within the partial region corresponding to the drain driver (see JP-A-2001-306040 (patent document 1) and JP-A-2000-137445 (patent document 2), for example).

Further, such a display device includes a control circuit (for example, timing controller or the like) which controls an operation of each drive circuit by supplying a control signal such as a clock signal which instructs operation timing to respective circuits. There may be a case that such a control circuit is mounted on a printed circuit board connected to the array substrate which is provided separately from the array substrate on which the display region is formed. However, aiming at the miniaturization of the whole device, the reduction of a manufacturing cost and the like due to the miniaturization of the printed circuit board, there may be also a case in which the control circuit is mounted on the array substrate together with the drive circuit or the like using a so-called COG (Chip On Glass) technique. Patent document 1 discloses an example in which a control circuit is mounted on the same substrate as a drive circuit.

### SUMMARY OF THE INVENTION

In the above-mentioned example, the plurality of drain drivers is arranged parallel to each other in a region outside the display region on the array substrate in the direction which intersects the extending direction of the video signal lines to which the signals are supplied. That is, in the example disclosed in the above-mentioned respective patent documents, the plurality of drain drivers which supplies the video signals to the respective video signal lines which extend in the longitudinal direction of the display region is arranged on a straight line which extends in the lateral direction of the display region. However, in the example disclosed in patent document 1, the timing controller is arranged away from the drain drivers which are controlled by the timing controller in the direction different from the drain drivers as viewed from the display region.

Here, to respond to a request relating to the arrangement of circuits, there may be a case that it is desirable to arrange a control circuit parallel to drive circuits in the same direction as viewed from a display region. FIG. 8 is a plan view showing one example of the arrangement of respective circuits on an array substrate where the control circuit is arranged on a straight line along which a plurality of drive circuits is arranged parallel to each other. In the example shown in the drawing, a display region 12 is formed on the array substrate 10, and a plurality of video signal lines 26 is arranged within the display region 12 parallel to each other in the longitudinal direction (Y-axis direction) of the display region 12. Further, corresponding to five respective partial regions 14a to 14e which are formed by dividing the display region 12 by dotted lines extending in the longitudinal direction (formed by dividing the display region into five regions in the lateral direction), five drain drivers 16a to 16e are arranged outside the display region 12. The respective drain drivers 16a to 16e and the respective video signal lines 26 within the corresponding partial regions are connected with each other via relay lines 28 respectively.

These five drain drivers 16a to 16e and a timing controller 18 are arranged on a straight line in the lateral direction (X-axis direction) of the display region 12. Further, on the array substrate 10, gate drivers 20a, 20b are arranged besides the drain drivers 16a to 16e. The gate drivers 20a, 20b supply signals to a plurality of scanning signal lines 30 extending in the X-axis direction which intersect the video signal lines 26 and being arranged parallel to each other in the Y-axis direction. Still further, a printed circuit board 24 is connected to the array substrate 10 via an FPC (flexible printed circuit) 22. On the printed circuit board 24, circuits which process video signals inputted from the outside and supply data signals and control signals obtained as a result of such processing to the timing controller 18 and the respective drivers are mounted. In the drawing, only portions of the plurality of video signal lines 26, relay lines 28 and scanning signal lines 30 are shown at intervals, while only portions of the respective video signal lines 26 and scanning signal lines 30 are shown.

As exemplified in the drawing, in arranging the control circuit and the plurality of drive circuits parallel to each other on the array substrate without expanding a size of the array substrate, it may be possible to arrange at least some drive circuits out of the plurality of drive circuits such that the center lines of the drive circuits extending in the Y-axis direction (that is, the center lines indicative of the centers in the X-axis direction) are arranged at positions displaced from center lines of the partial regions corresponding to the drive circuits which extend in the Y-axis direction, and to arrange the control circuit in an open region formed by the displacement. For example, in FIG. 8, although the drain driver 16c is arranged on the center line indicative of the center of the partial region 14c in the X-axis direction, all other drain drivers are arranged in a displaced manner from the center lines indicative of the centers of the corresponding partial regions in the X-axis direction. The timing driver 18 is arranged in the open region which is formed by arranging the drain drivers 16a, 16b at positions displaced from the center lines in the X-axis direction particularly.

In this manner, when a certain drive circuit is arranged in a displaced manner from the center line of the partial region corresponding to the drive circuit, there lay lines which connect the drive circuit and the respective video signal lines within the partial region corresponding to the drive circuit are arranged in left-and-right asymmetry. As a result, one relay line which is connected to the video signal line arranged at one edge of one partial region and another relay line which is connected to the video signal line arranged adjacent to one video signal line and is connected the video signal line arranged within another partial region different from one partial region largely differ in length.

FIG. 9 is a partially enlarged view of FIG. 8 and shows one example of the difference in length generated between these neighboring relay lines. To be more specific, in this drawing, to denote the partial region 14a in FIG. 8 as a target partial region, (a) the target video signal line 26a which is positioned at an edge of the target partial region 14a on a neighboring partial region (here, partial region 14b) side adjacent to the target partial region 14a out of the video signal lines 26 within the target partial region 14a, (b) the neighboring video signal line 26b which is positioned at an edge of the target partial region 14a on a target partial region 14 side out of the video signal lines 26 within the neighboring partial region 14b, (c) the target relay line 28a which connects the target video signal line 26a and the drain driver 16a, and (d) the neighboring relay line 28b which connects the neighboring video signal line 26b and the drain driver 16b are respectively shown. Here, although the target video signal line 26a and the neighboring video signal line 26b are arranged adjacent to each other, these video signal lines 26a, 26b receive the supply of signals from the different drain drivers respectively. As a result, as shown in the drawing, a length of the neighboring relay line 28b becomes longer than a length of the target relay line 28a, and the difference in length between both relay lines 28a, 28b is larger than the difference in length between other neighboring relay lines.

When the relay lines differ in length in this manner, the relay lines also differ in resistance value. Accordingly, even when the similar video signals are supplied to a plurality of video signal lines via these relay lines, the voltage difference is generated between these video signals thus generating the signal delay or the brightness difference among respective pixels. Particularly, in the example explained above, the drive circuit is arranged in a displaced manner with respect to the center line of the partial region corresponding to the drive circuit which extends in the Y-axis direction. Accordingly, there exists a possibility that large display irregularities are generated at a boundary position between the partial regions where the neighboring video signal lines receive the supply of signals from the different drive circuits. Although patent document 2 discloses an example in which the respective drive circuits are arranged at positions displaced from the center lines of the partial regions which correspond to the respective drive circuits, no consideration is taken into account with respect to the above-mentioned display irregularities in the boundary between the partial regions.

The invention has been made under such circumstances, and it is one of objects of the invention to provide a display device which can decrease display irregularities generated by the positional displacement of drive circuits when a control circuit is arranged parallel to a plurality of drive circuits on a substrate.

To overcome the above-mentioned drawbacks, according to one aspect of the invention, there is provided a display device which includes: a display region which is constituted of a plurality of partial regions; a plurality of video signal lines which extends in the first direction and is arranged parallel to each other in the second direction within the plurality of respective partial regions; a plurality of drive circuits which supplies video signals to the plurality of video signal lines within the partial regions; and a plurality of relay lines which connects the plurality of video signal lines and the plurality of drive circuits; wherein the plurality of partial regions is arranged in the second direction, and the plurality of drive circuits is arranged parallel to each other in the second direction outside the display region, a control circuit which controls an operation of the plurality of drive circuits is arranged parallel to the plurality of drive circuits, a center line of the drive circuit which extends in the first direction and a center line of the partial region corresponding to the drive circuit which extends in the first direction are arranged at positions displaced from each other, and the relay line has a bent portion between the drive circuit and the video signal line.

According to another aspect of the invention, there is provided a display device which includes: a display region which is constituted of a plurality of partial regions arranged in the second direction; a plurality of video signal lines which is arranged within each partial region, extends in the first direction, and is arranged parallel to each other in the second direction; a plurality of drive circuits each of which supplies video signals to the plurality of video signal lines arranged within the partial region; and a plurality of relay lines which connects the plurality of video signal lines and the plurality of drive circuits, wherein the drive circuits which are arranged corresponding to the plurality of partial regions are arranged parallel to each other in the second direction; a control circuit which controls an operation of the drive circuit is arranged parallel to the drive circuits in the second direction, a center line of the drive circuit which extends in the first direction is arranged at a position displaced from a center line of the partial region corresponding to the drive circuit which extends in the first direction, and the relay line which connects the video signal line in one partial region and the drive circuit has a length shorter than a length of the relay line which connects the video signal line in the neighboring partial region arranged adjacent to one partial region and the drive circuit and has a resistance value per unit length larger than a resistance value per unit length of the relay line which connects the video signal line in the neighboring partial region and the drive circuit.

According to still another aspect of the invention, there is provided a display device which includes: a display region which is constituted of a plurality of partial regions arranged in the second direction; a plurality of video signal lines which is arranged within each partial region, extends in the first direction, and is arranged parallel to each other in the second direction; a plurality of drive circuits each of which supplies video signals to the plurality of video signal lines arranged within the partial region; and a plurality of relay lines which connects the plurality of video signal lines and the plurality of drive circuits, wherein the drive circuits which are arranged corresponding to the plurality of partial regions are arranged parallel to each other in the second direction; a control circuit which controls an operation of the drive circuit is arranged parallel to the drive circuits in the second direction, a center line of the drive circuit which extends in the first direction is arranged at a position displaced from a center line of the partial region corresponding to the drive circuit which extends in the first direction, and a resistance value per unit length of each relay line is smaller than a resistance value per unit length of each video signal line.

According to further aspect of the invention, there is provided a display device which includes: a display region which is constituted of a plurality of partial regions arranged in the second direction; a plurality of video signal lines which is arranged within each partial region, extends in the first direction, and is arranged parallel to each other in the second direction; a plurality of drive circuits each of which supplies video signals to the plurality of video signal lines arranged within the partial region; and a plurality of relay lines which connects the plurality of video signal lines and the plurality of drive circuits, wherein the drive circuits which are arranged corresponding to the plurality of partial regions are arranged parallel to each other in the second direction; a control circuit which controls an operation of the drive circuit is arranged parallel to the drive circuits in the second direction, a center line of the drive circuit which extends in the first direction is arranged at a position displaced from a center line of the partial region corresponding to the drive circuit which extends in the first direction, and a pixel column is arranged in the first direction between the partial regions arranged adjacent to each other, and pixels included in the pixel column are connected to either one of the video signal line which belongs to one partial region and the video signal line which belongs to another partial region.

### BRIEF DESCRIPTION OF THE DRAWINGS

FIG. 1 is a plan view of an array substrate which constitutes a display device according to a first embodiment of the invention;

FIG. 2 is a plan view showing one example of a pixel circuit which is mounted on the array substrate;

FIG. 3 is a partially enlarged plan view of the array substrate shown in FIG. 1;

FIG. 4A is a cross-sectional view showing one example of the cross-sectional structure of a relay line used in a display device according to a second embodiment of the invention;

FIG. 4B is a cross-sectional view showing another example of the cross-sectional structure of the relay line used in the display device according to the second embodiment of the invention;

FIG. 4C is a cross-sectional view showing another example of the cross-sectional structure of the relay line used in the display device according to the second embodiment of the invention;

FIG. 4D is a cross-sectional view showing another example of the cross-sectional structure of the relay line used in the display device according to the second embodiment of the invention;

FIG. 4E is a cross-sectional view showing another example of the cross-sectional structure of the relay line used in the display device according to the second embodiment of the invention;

FIG. 5 is a cross-sectional view showing another example of the cross-sectional structure of the relay line used in the display device according to the second embodiment of the invention;

FIG. 6 is a schematic circuit diagram showing an example of connection between a pixel circuit and video signal lines in a display device according to a fourth embodiment of the invention;

FIG. 7 is a plan view showing another example of a pixel circuit mounted on the array substrate;

FIG. 8 is a plan view showing one example of the array substrate; and

FIG. 9 is a partially enlarged plan view of the array substrate shown in FIG. 8.

### DESCRIPTION OF THE PREFERRED EMBODIMENTS

(1) A display device according to the invention has the following constitutional features.

The display device includes a plurality of video signal lines which is arranged parallel to each other within a display region formed on a substrate and supplies video signals to pixels arranged within the display region. The display region is divided into a plurality of partial regions along the direction which intersects the respective video signal lines, and the plurality of video signal lines is arranged in each of the plurality of partial regions. The display device also includes a plurality of drive circuits each of which corresponds to one of the plurality of partial regions and supplies video signals to the video signal lines arranged within the partial region corresponding to the drive circuit. The plurality of drive circuits is arranged parallel to each other in the direction which intersects the respective video signal lines outside the display region formed on the substrate. The display device also includes a plurality of relay lines which connects the respective video signal lines arranged in the plurality of respective partial regions and the drive circuits corresponding to the partial regions outside the display region. The display device also includes a control circuit which is arranged on the substrate on a straight line along which the plurality of drive circuits is arranged and controls an operation of the plurality of drive circuits.

In at least one drive circuit out of the plurality of drive circuits, an imaginary center line which extends in the direction of the respective video signal lines is arranged at a position displaced from an imaginary center line of the partial region corresponding to the drive circuit which extends in the direction of the respective video signal lines.

The control circuit is arranged in an open region on the substrate which is generated due to the arrangement of at least one drive circuit in a displaced manner from the center line of the partial region corresponding to the drive circuit.

The relay line which is connected with the video signal line arranged on one edge of the partial region corresponding to the above-mentioned at least one drive circuit is arranged along a roundabout path having a length corresponding to a length of the relay line which is connected with the video signal line arranged adjacent to the former video signal line and arranged in the partial region different from the partial region where the former video signal line is arranged.

(2) In the display device having the above-mentioned constitution (1), the above-mentioned at least one drive circuit may be arranged at a position where the center line of the drive circuit which extends in the direction of the respective video signal lines is displaced with respect to the center line of the partial region corresponding to the drive circuit and extending in the direction of the respective video signal lines toward the center line of the display region which extends in the direction of the respective video signal lines.

(3) In the display device having the above-mentioned constitution (1), each one of the relay lines which are connected with the above-mentioned at least one drive circuit may be arranged along a path such that the difference in length between the relay line and other neighboring relay line arranged adjacent to the relay line assumes a predetermined value or less.

(4) Another display device according to the invention has the following constitutional features.

The display device includes a plurality of video signal lines which is arranged parallel to each other within a display region formed on a substrate and supplies video signals to pixels arranged within the display region. The display region is divided into a plurality of partial regions along the direction which intersects the extending direction of the respective video signal lines, and the plurality of video signal lines are arranged in each of the plurality of partial regions. The display device also includes a plurality of drive circuits each of which corresponds to one of the plurality of partial regions and supplies video signals to the video signal lines arranged within the partial region corresponding to the drive circuit. The plurality of drive circuits are arranged parallel to each other in the direction which intersects the respective video signal lines outside the display region formed on the substrate. The display device also includes a plurality of relay lines which connects the respective video signal lines arranged in the plurality of respective partial regions and the drive circuits corresponding to the partial regions outside the display region. The display device also includes a control circuit which is arranged on a straight line along which the plurality of drive circuits is arranged and controls an operation of the plurality of drive circuits.

In at least one drive circuit out of the plurality of drive circuits, in imaginary center line which extends in the direction of the respective video signal lines is arranged at a position displaced from an imaginary center line of the partial region corresponding to the drive circuit and extends in the direction of the respective video signal lines.

The control circuit is arranged in an open region on the substrate which is generated due to the arrangement of at least one drive circuit in a displaced manner from the imaginary center line of the partial region corresponding to the drive circuit.

The relay line which is connected with the video signal line arranged on one edge of the partial region corresponding to the above-mentioned at least one drive circuit has a shorter length and a larger resistance value per unit length than the relay line which is connected with the video signal line arranged adjacent to the former video signal line and arranged in the partial region different from the partial region where the former video signal line is arranged.

(5) In the display device having the above-mentioned constitution (4), each one of the respective relay lines which are connected to the above-mentioned at least one drive circuit may be configured such that the larger the length of the relay line, a resistance value of the relay line per unit length is decreased.

(6) In the display device having the above-mentioned constitution (4), some of the plurality of relay lines which is connected with the above-mentioned at least one drive circuit may be constituted of the stacked structure formed of a plurality of layers made of materials different from each other thus decreasing the resistance value per unit length.

(7) Still another display device according to the invention has the following constitutional features.

The display device includes a plurality of video signal lines which are arranged parallel to each other within a display region formed on a substrate and supplies video signals to pixels arranged within the display region. The display region is divided into a plurality of partial regions along the direction which intersects the respective video signal lines, and the plurality of video signal lines are arranged in each of the plurality of partial regions. The display device also includes a plurality of drive circuits each of which corresponds to one of the plurality of partial regions and supplies video signals to the video signal lines arranged within the partial region corresponding to the drive circuit. The plurality of drive circuits are arranged parallel to each other in the direction which intersects the respective video signal lines outside the display region formed on the substrate. The display device also includes a plurality of relay lines which connects the respective video signal lines arranged in the plurality of respective partial regions and the drive circuits corresponding to the partial regions outside the display region. The display device also includes a control circuit which is arranged on the substrate on a straight line along which the plurality of drive circuits is arranged and controls an operation of the plurality of drive circuits.

In at least one drive circuit out of the plurality of drive circuits, in imaginary center line which extends in the direction of the respective video signal lines is arranged at a position displaced from an imaginary center line of the partial region corresponding to the drive circuit and extends in the direction of the respective video signal lines.

The control circuit is arranged in an open region on the substrate which is generated due to the arrangement of at least one drive circuit in a displaced manner from the imaginary center line of the partial region corresponding to the drive circuit, and a resistance value per unit length of each relay line is smaller than a resistance value per unit length of each video signal line.

(8) In the display device having the above-mentioned constitution (7), each relay line may be made of a material having smaller resistivity than each video signal line thus decreasing the resistance value of the relay line per unit length.

(9) Still another display device according to the invention has the following constitutional features.

The display device includes a plurality of video signal lines which are arranged parallel to each other within a display region formed on a substrate and supplies video signals to pixels arranged within the display region. The display region is divided into a plurality of partial regions along the direction which intersects the respective video signal lines, and the plurality of video signal lines are arranged in each of the plurality of partial regions. The display device also includes a plurality of drive circuits each of which corresponds to one of the plurality of partial regions and supplies video signals to the video signal lines arranged within the partial region corresponding to the drive circuit. The plurality of drive circuits are arranged parallel to each other in the direction which intersects the respective video signal lines outside the display region formed on the substrate. The display device also includes a plurality of relay lines which connects the respective video signal lines arranged in the plurality of respective partial regions and the drive circuits corresponding to the partial regions outside the display region. The display device also includes a control circuit which is arranged on the substrate on a straight line along which the plurality of drive circuits is arranged and controls an operation of the plurality of drive circuits.

In at least one drive circuit out of the plurality of drive circuits, in imaginary center line which extends in the direction of the respective video signal lines is arranged at a position displaced from an imaginary center line of the partial region corresponding to the drive circuit and extends in the direction of the respective video signal lines.

The control circuit is arranged in an open region on the substrate which is generated due to the arrangement of at least one drive circuit in a displaced manner from the imaginary center line of the partial region corresponding to the drive circuit.

Out of pixels included in one pixel column positioned in a boundary between the target partial region corresponding to the above-mentioned at least one drive circuit and the neighboring partial region arranged adjacent to the target partial region, video signals are supplied to some pixels from the video signal line arranged within the target partial region and the video signals are supplied to the pixels other than some pixels from the video signal line arranged within the neighboring partial region respectively.

(10) In the display device having the above-mentioned constitution (9), out of pixels included in one pixel column, the video signals may be supplied to the above-mentioned some pixels from the video signal line arranged on a neighboring-partial-region-side edge within the target partial region, and the video signals may be supplied to the above-mentioned the pixels other than the above-mentioned some pixels from the video signal line arranged on a target-partial-region-side edge within the neighboring partial region.

(11) In the display device having the above-mentioned constitution (9), the above-mentioned some pixels and the above-mentioned pixels other than the above-mentioned some pixels are alternately arranged within one pixel column.

Hereinafter, embodiments of the invention are explained in conjunction with drawings. The explanation is made hereinafter with respect to a case where a display device according to the embodiments of the invention is a TFT-type liquid crystal display device, for example.

### First Embodiment

The display device according to the first embodiment of the invention is characterized by the following constitutional features.

The display device includes: a display region which is constituted of a plurality of partial regions 14a to 14e; a plurality of video signal lines 26 which extends in the first direction (Y direction) and is arranged parallel to each other in the second direction (X direction) within the plurality of respective partial regions; a plurality of drive circuits which supplies video signals to the plurality of video signal lines within the partial regions; and a plurality of relay lines which connects the plurality of video signal lines and the plurality of drive circuits.

The plurality of partial regions is arranged in the second direction, and the plurality of drive circuits is arranged parallel to each other in the second direction outside the display region.

A control circuit which controls an operation of the plurality of drive circuits is arranged parallel to the plurality of drive circuits.

Imaginary center lines 16a1 to 16e1 of the drive circuits which extend in the first direction and imaginary center lines 14a1 to 14e1 of the partial regions corresponding to the drive circuits which extend in the first direction are arranged at positions displaced from each other. Here, when the number of divided partial region is the odd number, the imaginary center line 14c1 of the partial region positioned at the center and the imaginary center line 16c1 of the drive circuit corresponding to the partial region are aligned with each other.

The relay lines have a bent portion 281 between the drive circuit and the video signal lines.

The relay lines which are connected to the drive circuit are arranged in asymmetry with respect to the center line of the drive circuit.

The relay lines which are connected to the drive circuit are arranged in asymmetry with respect to the center line of the partial region.

First of all, the display device according to the first embodiment of the invention is explained. The display device according to this embodiment is constituted of an array substrate and a filter substrate (also referred to as a counter substrate) which are arranged to face each other in an opposed manner, and a liquid crystal material which is filled in a region defined between both substrates. Thin film transistors (TFTs), pixel electrodes, various kinds of signal lines and the like are formed on the array substrate, while color filters (CFs) and the like are formed on the filter substrate. Both of the array substrate and the filter substrate are formed of a glass substrate, for example.

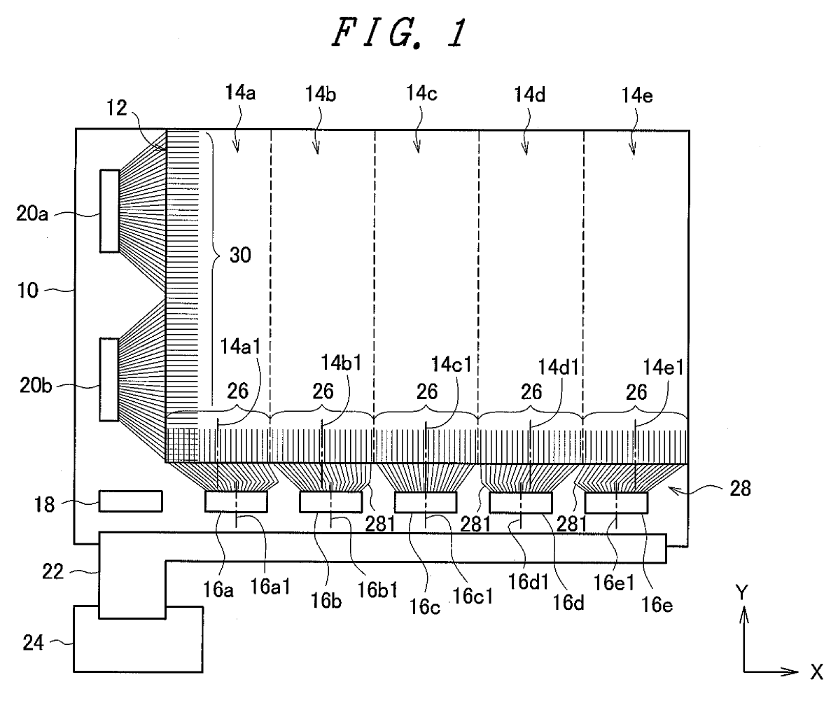

FIG. 1 is a plan view of the array substrate which constitutes the display device according to this embodiment. In FIG. 1, constitutional elements substantially equal to constitutional elements shown in FIG. 8 are given same reference symbols. As shown in FIG. 1, a display region 12 is formed on the array substrate 10, and a plurality of pixels is arranged in a matrix array within the display region 12. To be more specific, within the display region 12, a plurality of scanning signal lines 30 which extends in the lateral direction (X-axis direction) of the display region 12 and is arranged parallel to each other in the longitudinal direction (Y-axis direction) of the display region 12 is arranged. Further, a plurality of video signal lines 26 which extends in the longitudinal direction of the display region 12 and is arranged parallel to each other in the lateral direction of the display region 12 is arranged with in the display region 12. Each region defined by the scanning signal lines 30 and the video signal lines 26 corresponds to each pixel of the display device, and a display performed by these respective pixels is controlled by scanning signals supplied from the scanning signal lines 30 and video signals supplied from the video signal lines 26.

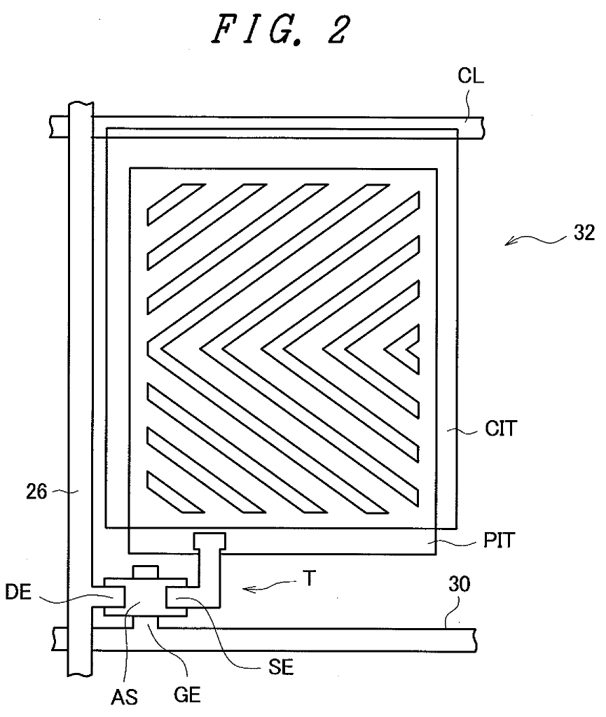

FIG. 2 is a plan view showing one example of a pixel circuit 32 which constitutes one of such pixels. In this embodiment, as a specific example, FIG. 2 shows a case where the display device according to this embodiment is an IPS (In Plane Switching)-type liquid crystal display device. As shown in FIG. 2, the pixel circuit 32 is constituted of a thin film transistor T, a pixel electrode PIT, and a common electrode CIT which faces the pixel electrode PIT in an opposed manner. Here, the thin film transistor T is constituted of a gate electrode GE, a drain electrode DE, a source electrode SE, and a semiconductor layer AS, wherein the source electrode SE is connected with the pixel electrode PIT, the drain electrode DE is connected with the video signal line 26, and the gate electrode GE is connected with the scanning signal line 30 respectively. The common electrode CIT is connected with the common signal line CL which extends parallel to the scanning signal line 30, and the common electrode CIT is held at a predetermined reference potential by the common signal line CL.

Here, the above-mentioned filter substrate has a size corresponding to a size of the display region 12 of the array substrate 10, and is arranged at a position where the filter substrate and the display region 12 face each other in an opposed manner. Depending on timing at which a scanning signal and a video signal are supplied to the each scanning signal line 30 and each video signal line 26, a pixel to which a display control is applied is selected. By applying a voltage to the pixel electrode PIT of the selected pixel via the thin film transistor T, a lateral electric field is generated between the pixel electrode PIT and the common electrode CIT thus controlling directions of the liquid crystal molecules. Due to a change of the directions of the liquid crystal molecules, a display of each pixel is controlled.

Further, as shown in FIG. 1, in a region of the array substrate 10 outside the display region 12 where the array substrate 10 does not face the filter substrate, as drive circuits which supply electric signals to the respective signal lines, five drain drivers 16a to 16e and two gate drivers 20a, 20b are arranged. The video signals are supplied to the respective video signal lines 26 from these drain drivers, while scanning signals are supplied to the respective scanning signal lines 30 from the gate drivers. As a control circuit which supplies control signals (for example, clock signals or the like) for controlling an operation of these drive circuits, a timing controller 18 is arranged on the array substrate 10. A printed circuit board 24 on which a circuit for supplying data signals and control signals to the respective circuits is mounted is connected to the array substrate 10 via an FPC 22.

Each one of drain drivers 16a to 16e corresponds to any one of the plurality of partial regions 14a to 14e which is formed by dividing the display region 12 in the direction of the respective video signal lines 26 on a one-to-one basis. Each drain driver supplies video signals to the respective video signal lines 26 which are arranged within the partial region corresponding to the drain driver. The respective video signal lines 26 within the display region 12 and the respective drain drivers are connected with each other via the relay lines 28 arranged outside the display region 12. That is, the respective video signal lines 26 are arranged in any one of the partial regions, and are connected with the drain driver corresponding to the partial region in which the video signal lines 26 are arranged via the relay lines 28.

Further, in this embodiment, outside the display region 12, five drain drivers 16a to 16e and the timing controller 18 are arranged on a straight line along the direction which intersects the respective video signal lines 26 (that is, in the lateral direction of the display region 12). At least one of the drain drivers 16a to 16e is arranged at a position where a center line of the drain driver which extends in the Y-axis direction is displaced from a center line of the partial region corresponding to the drain driver which extends in the Y-axis direction, and the timing controller 18 is arranged in an open region formed on the array substrate 10 due to such arrangement of the drain drivers 16a to 16e. To be more specific, as shown in FIG. 1, the drain drivers 16a, 16b are arranged in a displaced manner with respect to imaginary center lines of the partial regions 14a, 14b (that is, each center line indicative of the center of the partial region 14a, 14b in the X-axis direction) respectively corresponding to the drain drivers 16a, 16b which extend in the Y-axis direction toward a center line of the display region 12 in the Y-axis direction. The drain driver 16a which is remoter from the center line of the display region 12 than the drain driver 16b is more displaced from the center line of the corresponding partial region 14a. Due to such constitution, the open region is generated in the direction opposite to the direction that the drain driver 16a is displaced from the center line of the partial region 14a, and the timing controller 18 is arranged in the open region.

Further, the drain drivers 16d, 16e are also arranged in a displaced manner with respect to the center lines of the partial regions 14d, 14e corresponding to the drain drivers 16d, 16e which extend in the Y-axis direction toward the center line of the display region 12 extending in the Y-axis direction. Due to such a constitution, the respective drain drivers are arranged in a left-and-right symmetry with respect to the center line of the display region 12 extending in the Y axis direction using the drain driver 16c corresponding to the partial region 14c which is positioned at the center of the display region out of the plurality of drain drivers as the center. Hereinafter, the drain drivers which are arranged at positions displaced from the center lines of the partial region corresponding to the drain drivers (the drain drivers except for the drain driver 16c in this embodiment) are referred to as offset-arranged drivers.

Further, in this embodiment, different from the constitution shown in FIG. 8, at least some of relay lines 28 which are connected to the offset-arranged driver are arranged along roundabout paths. Hereinafter, the roundabout path of the relay lines 28 is explained.

Here, out of the video signal lines 26 arranged within the partial region corresponding to the each offset-arranged drivers, assume the video signal line 26 arranged at an edge of the partial region corresponding to the offset-arranged driver in the direction displaced from the center of the partial region as a target video signal line 26a. To be more specific, in FIG. 1, out of the video signal lines 26 which are arranged within the partial region corresponding to each offset-arranged driver, the video signal line 26 at an end on a side close to the partial region 14c constitutes the target video signal line 26a. Further, assume the video signal line 26 which is arranged adjacent to the target video signal line 26a within the display region 12 and is arranged in the partial region which differs from the partial region in which the target video signal line 26a is arranged (that is, the video signal line 26 connected to the drain driver different from the drain driver to which the target video signal line 26a is connected) as the neighboring video signal line 26b. Here, assume the relay line 28 which is connected to the target video signal line 26a as the target relay line 28a and the relay line 28 which is connected to the neighboring video signal line 26b as the neighboring relay line 28b, the target relay line 28a is arranged along a roundabout path having a length corresponding to a length of the neighboring relay line 28b. Due to such a constitution, the difference in distance from the drain driver to the video signal lines 26 between both relay lines can be adjusted to a predetermined value or less.

FIG. 3 is a partially-enlarged plan view of the array substrate 10 shown in FIG. 1 for showing a roundabout path of the target relay line 28a connected to the drain driver 16a which constitutes the offset-arranged driver. As shown in the drawing, the target relay line 28a is not linearly connected between the target video signal line 26a and the drain driver 16a, and is arranged along the roundabout path. Due to such a constitution, the target relay line 28a and the neighboring relay line 28b have the substantially equal length. In this manner, by arranging the target relay line 28a along the roundabout path having the length corresponding to the length of the neighboring relay line 28b, resistance values of both relay lines become substantially equal to each other and hence, the difference in signal attenuation ratio between a video signal supplied to the target video signal line 26a and a video signal line supplied to the neighboring video signal line 26b can be decreased thus preventing display irregularities in the boundary between the partial regions.

Here, as a matter of course, it is necessary to provide the roundabout path of the target relay line 28a at a position where the roundabout path of the target relay line 28a does not interfere with the path of the neighboring relay line 28b. However, when all drain drivers are displaced in the same direction so as to ensure an open region for arranging the timing controller 18, particularly, a displacement amount of the drain drivers arranged remote from the timing controller 18 from the center line of the corresponding partial region extending in the Y-axis direction becomes large and hence, it is impossible to acquire special tolerance necessary for providing the roundabout path of the target relay line 28a connected to such a drain driver while preventing the interference of the roundabout path with the path of the neighboring relay line 28b. To cope with such a situation, according to this embodiment, as described above, the respective drain drivers are arranged at positions displaced toward the center line of the display region 12 extending in the Y-axis direction thus preventing the accumulation of displacement amounts from the center lines of the partial regions corresponding to the respective drain drivers.

Further, in this embodiment, as exemplified in FIG. 3, out of the relay lines 28 which are connected to the offset-arranged drivers, not only the target relay line 28a arranged at an edge of the partial region but also other relay lines 28 are arranged along paths such that the difference in length between the relay line 28 and other relay line 28 arranged adjacent to the relay lines 28 becomes a predetermined value or less. Due to such a constitution, the difference in resistance value between the neighboring relay lines 28 can be reduced and hence, it is possible to make the generation of display irregularities attributed to positional displacement of the offset-arranged driver difficult also in regions other than the boundary between the partial regions.

In this embodiment, the path of the relay lines 28 which are connected to the drain driver 16a is shown as one example. However, also with respect to other offset-arranged drivers, as schematically shown in FIG. 1, the target video signal line 26a is arranged to have a length corresponding to a length of the neighboring video signal line 26b corresponding to a displacement amount of the offset-arranged driver from the center line of the partial region corresponding to each offset-arranged driver. The roundabout path of the relay line 28 illustrated in the drawing constitutes one example, and each relay line 28 may be arranged along a path having a shape different from the shape of the roundabout path shown in the drawing.

### Second Embodiment

Next, a display device according to the second embodiment of the invention is explained. Here, the explanation of constitutions and functions of the display device of this embodiment which are substantially equal to the corresponding constitutions and functions of the display device of the first embodiment is omitted. That is, only parts of the display device of this embodiment which differs from the parts of the display device of the first embodiment are explained. Further, constitutional elements substantially equal to the constitutional elements of the first embodiment are given same reference symbols.

The display device according to the second embodiment of the invention is characterized by the following constitutional features.

The display device includes: a display region which is constituted of a plurality of partial regions arranged in the second direction; a plurality of video signal lines which is arranged within each partial region, extends in the first direction, and is arranged parallel to each other in the second direction; a plurality of drive circuits each of which supplies video signals to the plurality of video signal lines arranged within the partial region; and a plurality of relay lines which connects the plurality of video signal lines and the plurality of drive circuits.

The drive circuits which are arranged corresponding to the plurality of partial regions are arranged parallel to each other in the second direction, and a control circuit which controls an operation of the drive circuit is arranged parallel to the drive circuits in the second direction.

A center line of the drive circuit which extends in the first direction is arranged at a position displaced from a center line of the partial region corresponding to the drive circuit which extends in the first direction, and the relay line which connects the video signal line in one partial region and the drive circuit has a length shorter than a length of the relay line which connects the video signal line in the neighboring partial region arranged adjacent to one partial region and the drive circuit and has a resistance value per unit length larger than a resistance value per unit length of the relay line which connects the video signal line in the neighboring partial region and the drive circuit.

The respective relay lines which are connected with at least one of the drive circuits are configured such that the resistance value per unit length is decreased corresponding to the increase of a length of the relay line.

Some relay lines out of the plurality of relay lines which is connected with at least one drive circuits is constituted by stacking a plurality of layers which differ in material from each other thus decreasing the resistance value per unit length.

In this embodiment, it is unnecessary to arrange each relay line 28 along the roundabout path shown in FIG. 1 or FIG. 3, and the relay line 28 may be arranged along an approximately straight path exemplified in FIG. 8. To arrange the relay line 28 along the approximately straight path instead of the roundabout path, the following constitution is adopted. With respect to each offset-arranged driver, the target relay line 28a which is connected with the target video signal line 26a arranged at one edge of the partial region corresponding to the offset-arranged driver has a shorter length and a larger resistance value per unit length than the relay line 28b connected with the neighboring video signal line 26b arranged adjacent to the target video signal line 26a and arranged within the partial region different from the partial region in which the target video signal line 26a is arranged. Here, the resistance value per unit length of the target relay line 28a is adjusted such that the resistance value of the whole target relay line 28a and the resistance value of the whole neighboring relay line 28b become substantially equal corresponding to the resistance value per unit length of the neighboring relay line 28b and a ratio between a length of the target relay line 28a and a length of the neighboring relay line 28b. Due to such constitution, it is possible to reduce display irregularities in the boundary between the partial regions in the same manner as the first embodiment.

Further, the respective relay lines 28 connected to the respective offset-arranged drivers may be configured such that the larger a length of the relay line 28, the smaller the resistance value per unit length of the relay line 28 becomes. Due to such a constitution, it is possible to adjust the resistance values of the respective relay lines 28 connected to each offset-arranged driver to an approximately equal value not only between the target relay line 28a and the neighboring relay line 28b but also among the respective relay lines 28.

Here, the explanation is made with respect to a specific example of a method which changes a resistance value per unit length of each relay lines 28. Each relay line 28 is configured such that one relay line 28 differs from other relay line 28 in at least one of a material and a cross-sectional area thereof corresponding to a length thereof. Due to such a constitution, it is possible to change the resistance value of each relay line 28. Further, in addition to merely changing the material or the cross-sectional area of the relay line 28, out of the plurality of relay lines 28 which is connected to the offset-arranged driver, some relay lines 28 may be formed of the stacked structure which is constituted of a plurality of layers made of materials different from each other. By allowing the relay line 28 to have the stacked structure constituted of the plurality of layers, it is possible to decrease the resistance value per unit length compared to the single-layered relay line 28 made of one kind of material.

To be more specific, plural kinds of cross-sectional structures are prepared as the cross-sectional structure of the relay line 28, and each one of plural kinds of cross-sectional structures and a range of length of the relay line 28 which adopts such kind of cross-sectional structure are associated with each other. Then, depending on the range to which the length of the relay line 28 belongs, the respective cross-sectional structures of the relay lines 28 connected to each drain driver are set to the kind of cross-sectional structure associated with such a range. Due to such a constitution, the respective relay lines 28 are classified into a plurality of groups corresponding to lengths thereof, and the different kinds of the cross-sectional structures are adopted corresponding to these groups.

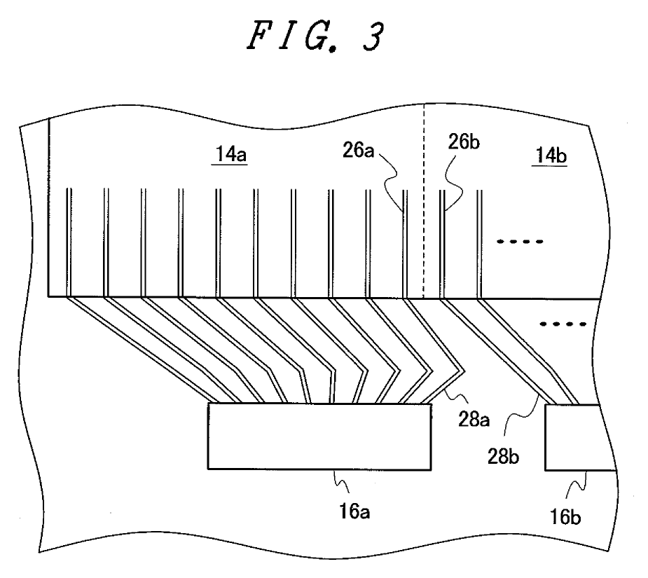

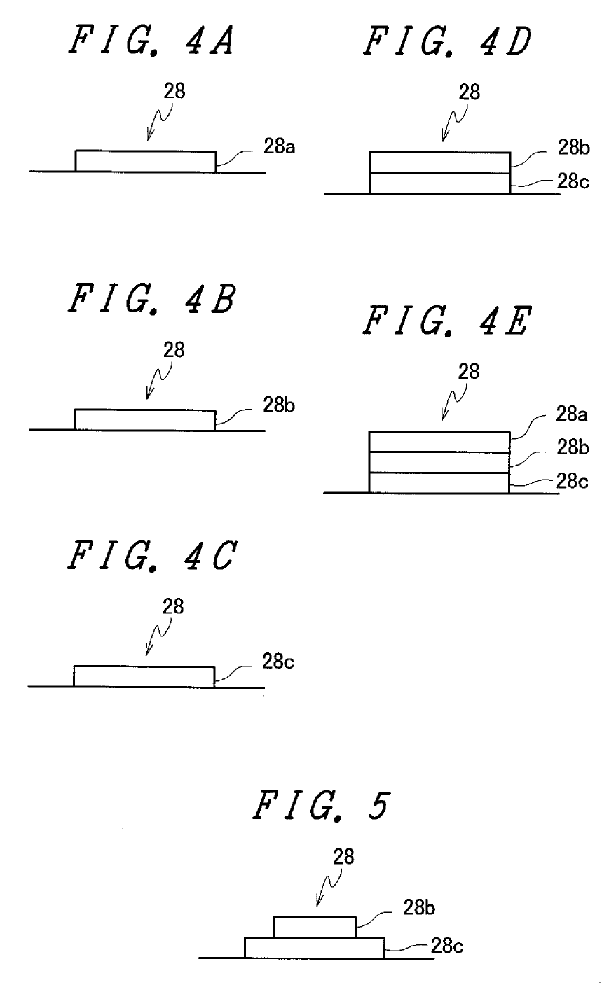

FIG. 4A to FIG. 4E respectively show one example of cross-sectional structures of the relay lines 28 of the plural kinds of the relay lines 28. All of FIG. 4A, FIG. 4B and FIG. 4C show the cross section of the single-layered relay line 28. The relay line 28 shown in FIG. 4A is formed of an ITO layer 28a made of ITO (Indium Tin Oxide), the relay line 28 shown in FIG. 4B is formed of a Cr layer 28b made of chromium (Cr), and the relay line 28 shown in FIG. 4C is formed of an Al layer 28c made of aluminum (Al). Further, FIG. 4D and FIG. 4E show the cross sections of the relay line 28 having the stacked structure which is formed by stacking plural kinds of materials. To be more specific, the relay line 28 shown in FIG. 4D has the two-layered cross-sectional structure formed by staking a Cr layer 28b on an Al layer 28c. Further, the relay line 28 shown in FIG. 4E has the three-layered cross-sectional structure formed by staking a Cr layer 28b on an Al layer 28c and further stacking an ITO layer 28a on the Cr layer 28b.

Here, ITO, chromium and aluminum possess electric resistivities which become smaller in this order. Accordingly, the relay lines 28 having the cross-sectional structures shown in FIG. 4A, FIG. 4B and FIG. 4C exhibit resistance values per unit length which become smaller in this order. Further, the relay line 28 shown in FIG. 4D, compared with the relay line 28 shown in FIG. 4C increases a cross-sectional area thereof by an amount corresponding to a Cr layer 28b which is integrally stacked on the Al layer 28c thus decreasing the resistance value per unit length. In the same manner, the relay line 28 shown in FIG. 4E decreases a resistance value per unit length thereof by an amount corresponding to the ITO layer 28a compared to the relay line 28 shown in FIG. 4D. That is, the relay lines 28 shown in FIG. 4A, FIG. 4B, FIG. 4C, FIG. 4D and FIG. 4E decrease the resistance values per unit length thereof in this order. Accordingly, in this embodiment, the relay line 28 adopts the cross-sectional structure in which the larger the length of the relay line 28, the smaller the resistance value per unit length becomes such that the relay line 28 having a length below a predetermined value has the cross-sectional structure shown in FIG. 4A and the relay line 28 having a length which falls within a predetermined range longer than the predetermined value has the cross-sectional structure shown in FIG. 4B, . . . . Due to such a constitution, it is possible to decrease irregularities of resistance values of the respective relay lines 28 as a whole thus preventing display irregularities attributed to the difference in resistance value among the respective relay lines 28.

With respect to any one of the respective materials exemplified above, materials which are used for mounting circuits within the display region 12 can be used. For example, in the example of the pixel circuit 32 shown in FIG. 2, the pixel electrodes PIT and the common electrodes CIT are made of ITO which is a transparent conductive material, the video signal lines 26, the drain electrodes DE and the source electrodes SE are made of chromium, and the scanning signal lines 30 and the gate electrodes GE are made of aluminum. Here, for example, simultaneously with the formation of the scanning signal lines 30 and the gate electrodes GE on the array substrate 10, the relay lines 28 formed of the Al layer 28c are formed. Further, the relay line 28 having the stacked structure formed of the plurality of materials may be formed together in a step in which the respective parts within the display region 12 are formed by stacking the plurality of materials in the same order as stacking the respective materials within the display region 12. By forming the relay lines 28 in this manner, it is possible to form the relay line 28 made of various kinds of materials or the relay line 28 formed by stacking plural layers made of various kinds of materials can be formed without increasing the number of manufacturing steps.

Further, in the above-mentioned example, the plural kinds of relay lines 28 having the resistance values per unit length which differ from each other are formed by adjusting kinds and number of materials to be stacked. However, in addition to such adjustment of kinds and the number of materials to be stacked, a cross-sectional area of the relay line 28 may be changed by changing lateral widths of one or more layers to be stacked corresponding to a length of each relay line 28. For example, FIG. 5 shows an example of the relay line 28 which narrows a lateral width of the Cr layer 28b which constitutes the second layer in the relay line 28 having the two-layered structure shown in FIG. 4D. By narrowing the lateral width of the Cr layer 28 in this manner, the relay line 28 having a cross-sectional shape shown in FIG. 5 increases a resistance value per unit length compared to the relay line 28 shown in FIG. 4D and decreases the resistance value per unit length compared to the relay line 28 shown in FIG. 4C. With the use of the relay line 28 having the cross-sectional shape which changes the lateral widths of one or more layers, it is possible to more finely adjust the resistance values per unit length of the respective relay lines 28 corresponding to the lengths of the relay lines 28.

### Third Embodiment

Next, a display device according to the third embodiment of the invention is explained. Here, also in this embodiment, the explanation of constitutions and functions of the display device of this embodiment which are substantially equal to the corresponding constitutions and functions of the display device of the first embodiment is omitted. That is, only parts of the display device of this embodiment which differ from the parts of the display device of the first embodiment are explained. Further, constitutional elements of this embodiment substantially equal to the constitutional elements of the first embodiment are given same reference symbols.

The display device according to the third embodiment of the invention is characterized by the following constitutional features.

The display device includes: a display region which is constituted of a plurality of partial regions arranged in the second direction; a plurality of video signal lines which is arranged within each partial region, extends in the first direction, and is arranged parallel to each other in the second direction; a plurality of drive circuits each of which supplies video signals to the plurality of video signal lines arranged within the partial region; and a plurality of relay lines which connects the plurality of video signal lines and the plurality of drive circuits.

The drive circuits which are arranged corresponding to the plurality of partial regions are arranged parallel to each other in the second direction, and a control circuit which controls an operation of the drive circuit is arranged parallel to the drive circuits in the second direction.

A center line of the drive circuit which extends in the first direction is arranged at a position displaced from a center line of the partial region corresponding to the drive circuit which extends in the first direction.

A resistance value per unit length of each relay line is smaller than a resistance value per unit length of each video signal line.

Each relay line is made of a material having resistivity smaller than resistivity of each video signal line so as to exhibit a smaller resistance value per unit length than said each video signal line.

The array substrate 10 of the display device according to this embodiment, in the same manner as the second embodiment, exhibits the appearance similar to the appearance shown in FIG. 8. In this embodiment, a resistance value per unit length of each relay line 28 is set smaller than a resistance value per unit length of each video signal line 26. For example, each relay line 28 is made of a material having smaller electric resistivity than a material used for forming the video signal line 26. As a specific example, when each video signal line 26 within the display region 12 is made of chromium as described previously, each relay lines 28 is made of aluminum, and the relay line 28 is connected with the video signal line 26 made of chromium in a boundary portion of the display region 12. In this embodiment, the resistance values of the respective relay lines 28 exhibit irregularities due to the difference in length of the relay line. However, by decreasing the resistance values per unit length of the whole relay lines 28 as explained above, it is possible to suppress irregularities in resistance value of the relay lines 28. Due to such a constitution, the influence which the irregularities of the resistance value exert on video signals can be made relatively small thus suppressing display irregularities in a boundary portion between the respective partial regions.

### Fourth Embodiment

Next, a display device according to the fourth embodiment of the invention is explained. Here, also in this embodiment, the explanation of constitutions and functions of the display device of this embodiment which are substantially equal to the corresponding constitutions and functions of the display device of the first embodiment is omitted. That is, parts of the display device of this embodiment which differs from the parts of the display device of the first embodiment are explained. Further, constitutional elements of this embodiment substantially equal to the constitutional elements of the first embodiment are given same reference symbols.

The display device according to the fourth embodiment of the invention is characterized by the following constitutional features.

The display device includes: a display region which is constituted of a plurality of partial regions arranged in the second direction; a plurality of video signal lines which is arranged within each partial region, extends in the first direction, and is arranged parallel to each other in the second direction; a plurality of drive circuits each of which supplies video signals to the plurality of video signal lines arranged within the partial region; and a plurality of relay lines which connects the plurality of video signal lines and the plurality of drive circuits.

The drive circuits which are arranged corresponding to the plurality of partial regions are arranged parallel to each other in the second direction, and a control circuit which controls an operation of the drive circuit is arranged parallel to the drive circuits in the second direction.

A center line of the drive circuit which extends in the first direction is arranged at a position displaced from a center line of the partial region corresponding to the drive circuit which extends in the first direction.

A pixel column is arranged in the first direction between the partial regions arranged adjacent to each other, and pixels included in the pixel column are connected to either one of the video signal line which belongs to one partial region and the video signal line which belongs to another partial region.

The video signal lines which are connected with the respective pixels of the pixel column are respectively positioned at edge portions of the partial regions arranged adjacent to each other.

The pixels of the pixel column are connected with the video signal line which belongs to one partial region and the video signal line which belongs to another partial region alternately.

The array substrate 10 of the display device according to this embodiment, in the same manner as the second embodiment, exhibits the appearance similar to the appearance shown in FIG. 8. In the explanation made hereinafter, the partial region which corresponds to one of the offset-arranged drivers is referred to as a target partial region, and a partial region which is arranged adjacent to the target partial region is referred to as a neighboring partial region. Also in this embodiment, out of pixels included in one pixel column (hereinafter, referred to as a boundary pixel column C) positioned in the boundary between the target partial region and the neighboring partial region, a video signal is supplied to some pixels from the video signal line 26 arranged within the target partial region, and the video signal is supplied to other pixels besides the above-mentioned some pixels from the video signal line 26 arranged within the neighboring partial region. That is, the video signal is supplied to the plurality of pixels included in one boundary pixel column C from both of one offset-arranged driver and the drain driver arranged adjacent to the offset-arranged driver. Here, the pixel column indicates a set of pixels which are arranged in the direction along the video signal line 26 (Y-axis direction) within the display region 12.

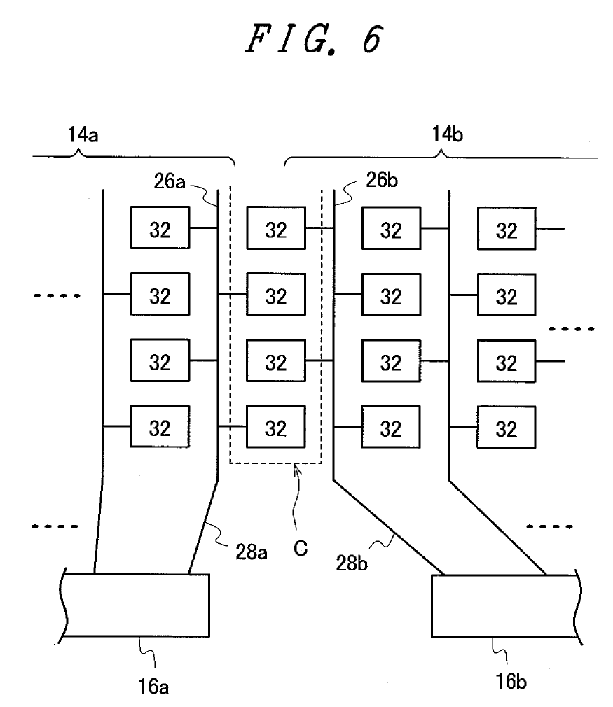

FIG. 6 is a circuit diagram which schematically shows a connection example of pixel circuits 32 and the video signal lines 26 in this embodiment. Here, assume a partial region 14a which corresponds to a drain driver 16a as a target partial region, and a partial region 14b which corresponds to a drain driver 16b as a neighboring partial region. In this example shown in FIG. 6, the pixel circuits 32 which constitute the respective pixel columns are alternately connected to the video signal lines 26 arranged on both sides of the pixel column every one other. That is, to focus on each pixel column, when one pixel circuit 32 is connected with one of the video signal lines 26 arranged on both sides of the pixel column, the pixel circuit 32 which is arranged adjacent to such a pixel circuit 32 in the same pixel column is connected to another video signal line 26 on the opposite side. Accordingly, the pixels included in the boundary pixel column C positioned in the boundary between the target partial region and the neighboring partial region also receive the supply of video signals from two video signal lines 26 positioned on both sides of the boundary pixel column C. These two video signal lines 26 respectively receive the supply of the video signal from the drain driver 16a corresponding to the target partial region and the drain driver 16b corresponding to the neighboring partial region.

In this manner, due to the presence in mixture of the pixels which receive the supply of signals from the drain driver 16a corresponding to the target partial region and the pixels which receive the supply of signals from the drain driver 16b corresponding to the neighboring partial region in the boundary pixel column C, even when difference exists in an electric resistance value between the relay lines 28 connected with the video signal lines 26 arranged on one side of the boundary pixel column C and the relay lines 28 connected with the video signal lines 26 arranged on another side of the boundary pixel column C, the pixels which are influenced by the relay lines 28 from the respective sides exist in mixture in the boundary pixel column C and hence, display irregularities in the boundary between the partial regions can be reduced.

Particularly with respect to example shown in FIG. 6, out of the pixels included in the boundary pixel column C, some pixels receive the supply of the video signal from a target video signal line 26a arranged on a neighboring-partial-region-side edge of the target partial region, while pixels other than the above-mentioned some pixels receive the supply of the video signals from a neighboring video signal line 26b which is arranged on a target-partial-region-side of the neighboring partial region. Further, the pixel circuit 32 which is connected to the target video signal line 26a and the pixel circuits 32 which is connected to the neighboring video signal line 26b are alternately arranged within the boundary pixel column C every one other. Due to such a constitution, both of the pixels which are controlled in response to the video signals supplied from the target video signal line 26a and the pixels which are controlled in response to the video signals supplied from the neighboring video signal line 26b are uniformly arranged within the boundary pixel column C and hence, the display irregularities within the boundary pixel column C are hardly generated.

Although the invention has been explained in conjunction with several embodiments, the invention is not limited to such embodiments.

For example, the constitution of the respective embodiments explained heretofore may be used in combination. As a specific example, the target relay line 28a may adopt a roundabout path corresponding to a length of the neighboring relay line 28b and, at the same time, may have a large resistance value per unit length compared to the neighboring relay lines 28b. Such a constitution can decrease the difference in resistance value between the target relay line 28a and the neighboring relay line 28b with the roundabout path further smaller than the roundabout path in the example shown in FIG. 3.

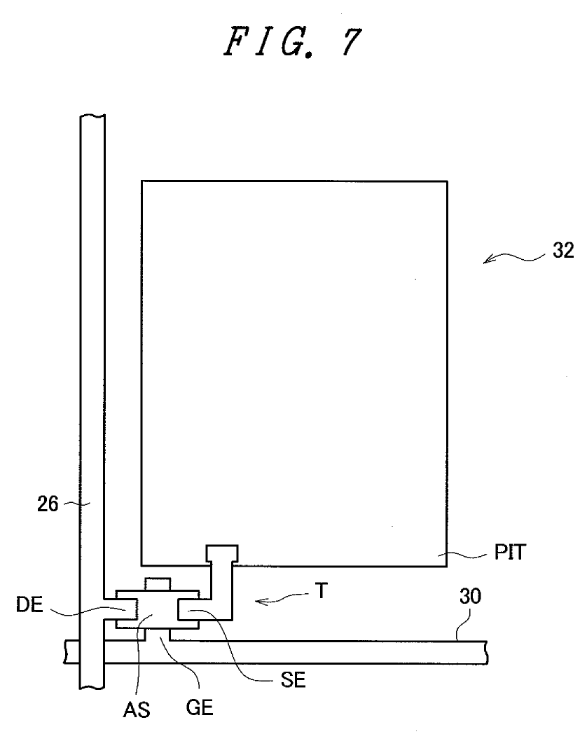

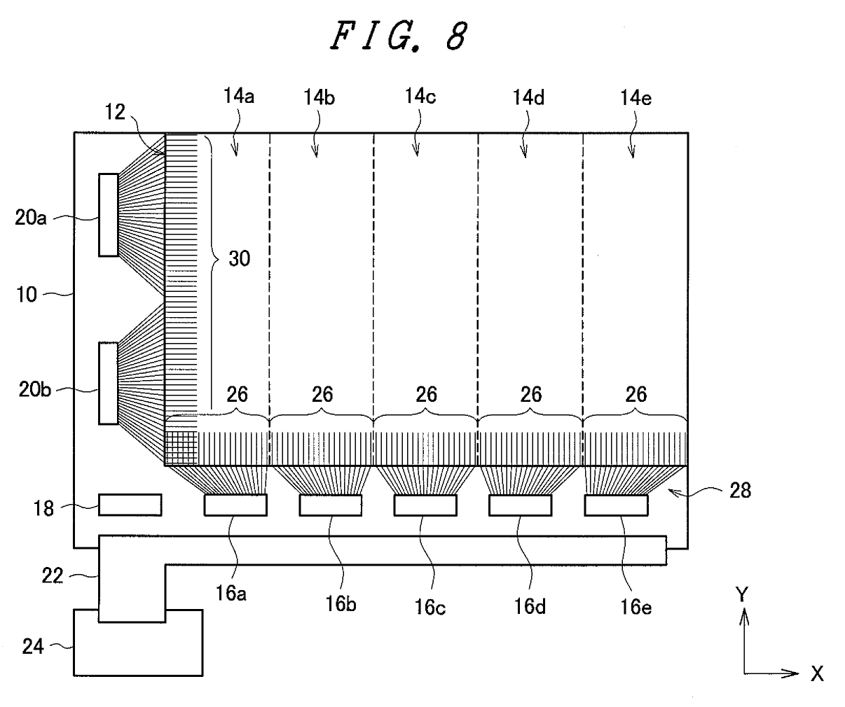

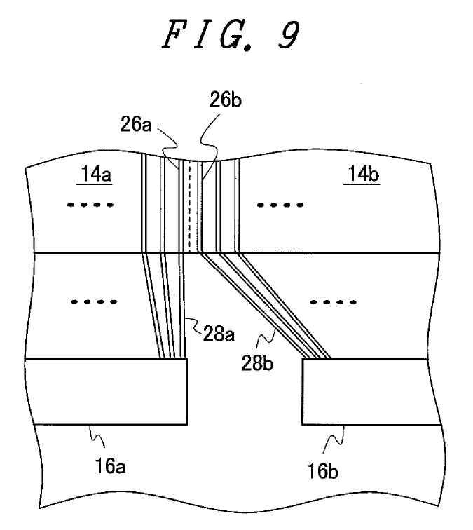

Further, the liquid crystal display device according to the embodiment of the invention is not limited to the IPS-type liquid crystal display device, and may be a liquid crystal display devices adopting various other methods and structures such as a VA (Vertical Alignment)-type liquid crystal display device, and TN (Twisted Nematic)-type liquid crystal display device. FIG. 7 is a plan view showing one example of pixel circuits 32 on an array substrate 10 which corresponds to FIG. 2 when the liquid crystal display device according to an embodiment of the invention is a VA-type liquid crystal display device or a TN-type liquid crystal display device. In the example shown in the drawing, different from an IPS-type liquid crystal display device, common electrodes CIT and common signal lines CL are not mounted on an array substrate 10 side, and the common electrodes CIT are mounted on a filter substrate instead.

Further, the display device according to the embodiments of the invention is not limited to the liquid crystal display device, and may be any kind of display device provided that a plurality of drive circuits which supplies video signals to respective pixels and a control circuit which controls an operation of these drive circuits are mounted on an array substrate. To be more specific, the display device according to the embodiment of the invention may be an organic EL display device, for example.

What is claimed is:

1. A display device comprising:
a display region which is constituted of a plurality of partial regions;
a plurality of video signal lines which extends in the first direction and is arranged parallel to each other in the second direction within the plurality of respective partial regions;
a plurality of drive circuits which supplies video signals to the plurality of video signal lines within the partial regions; and
a plurality of relay lines which connects the plurality of video signal lines and the plurality of drive circuits; wherein
the plurality of partial regions is arranged in the second direction, and the plurality of drive circuits is arranged parallel to each other in the second direction outside the display region,
a control circuit which controls an operation of the plurality of drive circuits is arranged parallel to the plurality of drive circuits,
a center line of the drive circuit which extends in the first direction and a center line of the partial region corresponding to the drive circuit which extends in the first direction are arranged at positions displaced from each other, and
the relay line has a bent portion between the drive circuit and the video signal line.

2. A display device according to claim 1, wherein the relay lines which are connected to the drive circuit are arranged in asymmetry with respect to the center line of the drive circuit.

3. A display device according to claim 1, wherein the relay lines which are connected to the drive circuit are arranged in asymmetry with respect to the center line of the partial region.

4. A display device comprising:
a display region which is constituted of a plurality of partial regions arranged in the second direction;
a plurality of video signal lines which is arranged within each partial region, extends in the first direction, and is arranged parallel to each other in the second direction;
a plurality of drive circuits each of which supplies video signals to the plurality of video signal lines arranged within the partial region; and
a plurality of relay lines which connects the plurality of video signal lines and the plurality of drive circuits, wherein
the drive circuits which are arranged corresponding to the plurality of partial regions are arranged parallel to each other in the second direction;
a control circuit which controls an operation of the drive circuit is arranged parallel to the drive circuits in the second direction,
a center line of the drive circuit which extends in the first direction is arranged at a position displaced from a center line of the partial region corresponding to the drive circuit which extends in the first direction, and
the relay line which connects the video signal line in one partial region and the drive circuit has a length shorter than a length of the relay line which connects the video signal line in the neighboring partial region arranged adjacent to said one partial region and the drive circuit and has a resistance value per unit length larger than a resistance value per unit length of the relay line which connects the video signal line in the neighboring partial region and the drive circuit.

5. A display device according to claim 4, wherein the respective relay lines which are connected with at least one of the drive circuits are configured such that the resistance value per unit length is decreased corresponding to the increase of a length of the relay line.

6. A display device according to claim 5, wherein some relay lines out of the plurality of relay lines which is connected with at least one drive circuits is constituted by stacking a plurality of layers which differ in material from each other thus decreasing the resistance value per unit length.

7. A display device comprising:
a display region which is constituted of a plurality of partial regions arranged in the second direction;
a plurality of video signal lines which is arranged within each partial region, extends in the first direction, and is arranged parallel to each other in the second direction;
a plurality of drive circuits each of which supplies video signals to the plurality of video signal lines arranged within the partial region; and
a plurality of relay lines which connects the plurality of video signal lines and the plurality of drive circuits, wherein
the drive circuits which are arranged corresponding to the plurality of partial regions are arranged parallel to each other in the second direction;
a control circuit which controls an operation of the drive circuit is arranged parallel to the drive circuits in the second direction,
a center line of the drive circuit which extends in the first direction is arranged at a position displaced from a center line of the partial region corresponding to the drive circuit which extends in the first direction, and
a resistance value per unit length of each relay line is smaller than a resistance value per unit length of each video signal line.

8. A display device according to claim 7, wherein said each relay line is made of a material having resistivity smaller than resistivity of said each video signal line so as to exhibit a smaller resistance value per unit length than said each video signal line.

9. A display device comprising:
a display region which is constituted of a plurality of partial regions arranged in the second direction;
a plurality of video signal lines which is arranged within each partial region, extends in the first direction, and is arranged parallel to each other in the second direction;
a plurality of drive circuits each of which supplies video signals to the plurality of video signal lines arranged within the partial region; and
a plurality of relay lines which connects the plurality of video signal lines and the plurality of drive circuits, wherein
the drive circuits which are arranged corresponding to the plurality of partial regions are arranged parallel to each other in the second direction;
a control circuit which controls an operation of the drive circuit is arranged parallel to the drive circuits in the second direction,
a center line of the drive circuit which extends in the first direction is arranged at a position displaced from a center line of the partial region corresponding to the drive circuit which extends in the first direction, and
a pixel column is arranged in the first direction between the partial regions arranged adjacent to each other, and pixels included in the pixel column are connected to either one of the video signal line which belongs to one partial region and the video signal line which belongs to another partial region.

10. A display device according to claim 9, wherein the video signal lines which are connected with the respective pixels of the pixel column are respectively positioned at edge portions of the partial regions arranged adjacent to each other.

11. A display device according to claim 9, wherein the pixels of the pixel column are connected with the video signal line which belongs to one partial region and the video signal line which belongs to another partial region alternately.
